(19) United States
(12) Patent Application Publication
(10) Pub. No.: US 2026/0349320 A1
(43) Pub. Date: Nov. 5, 2026

(54) ELECTRONIC DEVICE AND PROJECTOR

(71) Applicant: SAMSUNG ELECTRONICS CO., LTD., Suwon-si (KR)

(72) Inventors: Jisu KIM, Suwon-si (KR); Daegun HONG, Suwon-si (KR); Daesu CHOI, Suwon-si (KR); Yousub LEE, Suwon-si (KR); Hunsung KIM, Suwon-si (KR)

(73) Assignee: SAMSUNG ELECTRONICS CO., LTD., Suwon-si (KR)

(21) Appl. No.: 19/716,622

(22) Filed: Jun. 23, 2026

Related U.S. Application Data
(63) Continuation of application No. PCT/KR2026/001184, filed on Jan. 20, 2026.

(30) Foreign Application Priority Data
Feb. 24, 2025 (KR) 10-2025-0023963

(51) Int. Cl. G03B 21/14; H04N 9/31

(52) U.S. Cl. CPC G03B 21/142; G03B 21/145; H04N 9/3173

(57) ABSTRACT

Provided is an electronic device including a fixed frame, a rotating frame rotatable relative to the fixed frame, a motor configured to provide power for rotating the rotating frame, a rotating shaft configured to be rotated by the motor, a first gear detachably coupled to the rotating shaft and rotatable by power from the motor transmitted through the rotating shaft, and a second gear configured to engage with the first gear such that the rotating frame rotates relative to the fixed frame. The rotating frame is rotatable relative to the fixed frame by external force when the first gear and the second gear are separated.

### CROSS-REFERENCE TO RELATED APPLICATION

This application is a continuation application of International Application No. PCT/KR2026/001184, filed on Jan. 20, 2026, which is based on and claims priority to Korean Patent Application No. 10-2025-0023963, filed on Feb. 24, 2025, in the Korean Intellectual Property Office, the disclosures of which are incorporated by reference herein in their entireties.

### BACKGROUND

### 1. Field

The present disclosure relates to an electronic device and projector having an improved structure.

### 2. Description of Related Art

Electronic devices may include a main body and wheels provided to move the main body. With such a configuration, the electronic device may be easily moved within a space.

The electronic device may include a sensor for detecting obstacles. The electronic device may use information detected by the sensor to avoid obstacles or to map a movable area.

The electronic device having the above configuration may further include a projector that is movably provided to project an image onto an arbitrary area. The electronic device may project video and/or images onto any area. A part of the electronic device may rotate to adjust the projection area of the video and/or images.

However, when a failure occurs in a motor that utilizes a worm gear, reverse rotation of the worm gear cannot be physically achieved due to the worm gear's self-locking characteristic, and therefore the rotating part of the electronic device cannot be manually rotated for maintenance.

### SUMMARY

An electronic device according to an embodiment includes: a fixed frame; a rotating frame rotatable relative to the fixed frame; a motor configured to provide power for rotating the rotating frame; a rotating shaft configured to be rotated by the motor; a first gear detachably coupled to the rotating shaft and rotatable by power from the motor transmitted through the rotating shaft; and a second gear configured to engage with the first gear such that the rotating frame rotates relative to the fixed frame. The rotating frame is rotatable relative to the fixed frame by external force when the first gear and the second gear are separated.

### BRIEF DESCRIPTION OF THE DRAWINGS

These and/or other aspects, features, and advantages of certain embodiments of the disclosure will be more apparent from the following description taken in conjunction with the accompanying drawings, in which:

FIG. 1 is a perspective view of an electronic device according to an embodiment of the present disclosure.

FIG. 2 is an exploded perspective view of an electronic device according to an embodiment of the present disclosure.

FIG. 3 is a perspective view of the inside of an electronic device according to an embodiment of the present disclosure.

FIG. 4 is an exploded view of the inside of an electronic device according to an embodiment of the present disclosure.

FIG. 5 is a view showing a fixed frame disassembled from a rotating frame according to an embodiment of the present disclosure.

FIG. 6 is a cross-sectional perspective view of an electronic device according to an embodiment of the present disclosure.

FIG. 7 is an exploded view depicting a power transmission device according to an embodiment of the present disclosure.

FIG. 8 is an exploded view of a power transmission device according to an embodiment of the present disclosure.

FIG. 9 is an enlarged view of the inside of an electronic device according to an embodiment of the present disclosure.

FIG. 10 is a cross-sectional view of an electronic device according to an embodiment of the present disclosure.

FIG. 11 is a cross-sectional view of the electronic device shown in FIG. 10 with a first gear separated.

### DETAILED DESCRIPTION

Various embodiments of the present document and terms used therein are not intended to limit the technical features described in this document to specific embodiments, and should be understood to include various modifications, equivalents, or substitutes of the corresponding embodiments.

In connection with the description of the drawings, similar reference numerals may be used for similar or related components.

The singular form of a noun corresponding to an item may include one or a plurality of the items unless clearly indicated otherwise in a related context.

In this document, phrases, such as “A or B”, “at least one of A and B”, “at least one of A or B,” “A, B or C,” “at least one of A, B and C,” and “at least one of A, B, or C”, may include any one or all possible combinations of items listed together in the corresponding phrase among the phrases. For example, expressions such as “at least one of,” when preceding a list of elements, modify the entire list of elements and do not modify the individual elements of the list. For example, the expression, “at least one of A, B, or C,” should be understood as including only A, only B, only C, both A and B, both A and C, both B and C, or all of A, B, and C.

As used herein, the term “and/or” includes any and all combinations of one or more of associated listed items.

Terms, such as “1st”, “2nd”, “primary”, or “secondary” may be used simply to distinguish a component from other components, without limiting the component in other aspects (e.g., importance or order).

When one (e.g., a first) element is referred to as being “coupled” or “connected” to another (e.g., a second) element with or without the term “functionally” or “communicatively,” it means that the one element is connected to the other element directly, wirelessly, or via a third element.

It will be understood that when the terms “includes,” “comprises,” “including,” and/or “comprising,” when used in this specification, specify the presence of stated features, figures, steps, operations, components, members, or combinations thereof, but do not preclude the presence or addition of one or more other features, figures, steps, operations, components, members, or combinations thereof.

It will be understood that when a certain component is referred to as being “connected to”, “coupled to”, “supported by” or “in contact with” another component, it may be directly or indirectly connected to, coupled to, supported by, or in contact with the other component. When a component is indirectly connected to, coupled to, supported by, or in contact with another component, it may be connected to, coupled to, supported by, or in contact with the other component through a third component.

It will also be understood that when a component is referred to as being “on” another component, it may be directly on the other component or intervening components may also be present.

Terms such as “unit”, “module”, and “member” may be embodied as hardware or software. According to one or more embodiments, a plurality of “unit”, “module”, and “member” may be implemented as a single component or a single “unit”, “module”, and “member” may include a plurality of components.

The terms, such as “~part”, “~device”, “~block”, “~member”, “~module”, and the like may refer to a unit for processing at least one function or act. For example, the terms may refer to at least process processed by at least one hardware, such as a field-programmable gate array (FPGA) and/or application specific integrated circuit (ASIC), software stored in memories, or processors.

In each operation, an identification symbol is used to refer to each operation, the identification symbol does not limit the order of each operation, and each operation may be performed in an order different from the described order unless the context clearly indicates a specific order.

For example, the terms “front” and “rear” may refer to the +X direction and the −X direction shown in the drawings, respectively. The terms “upward” and “downward” may refer to the +Z direction and the −Z direction shown in the drawings, respectively. The terms “left direction” and “right direction” may refer to the +Y direction and the −Y direction shown in the drawings, respectively. The term “vertical direction” may refer to the Z direction shown in the drawings, and the term “horizontal direction” may refer to the Y direction shown in the drawings

An electronic device according to an embodiment includes: a fixed frame; a rotating frame rotatable relative to the fixed frame; a motor configured to provide power for rotating the rotating frame; a rotating shaft configured to be rotated by the motor; a first gear detachably coupled to the rotating shaft and rotatable by power from the motor transmitted through the rotating shaft; and a second gear configured to engage with the first gear such that the rotating frame rotates relative to the fixed frame. The rotating frame is rotatable relative to the fixed frame by external force when the first gear and the second gear are separated.

A projector for projecting an image according to an embodiment includes: a fixed frame; a rotating frame rotatable with respect to the fixed frame; a projection lens provided on the rotating frame and configured to project an image onto an arbitrary region; a motor configured to provide power for rotating the rotating frame; and a power transmission device configured to transmit the power of the motor to the fixed frame. The power transmission device includes a worm gear rotated by the power of the motor, and a first gear connected to the worm gear and rotatable therewith. The projector further includes a second gear connected to the fixed frame and configured to engage with the first gear. The first gear is separable from the second gear.

An electronic device according to an embodiment includes: a fixed frame; a rotating frame rotatable with respect to the fixed frame; a motor provided on the rotating frame; a worm gear rotated by the power of the motor; a rotating shaft rotated by the worm gear; a first gear rotatable by the power of the motor transmitted through the rotating shaft; and a second gear configured to engage with the first gear such that the rotating frame rotates with respect to the fixed frame. The rotating frame is rotatable with respect to the fixed frame by an external force when the first gear and the second gear are separated.

Hereinafter, embodiments of the present disclosure will be described in detail with reference to the accompanying drawings.

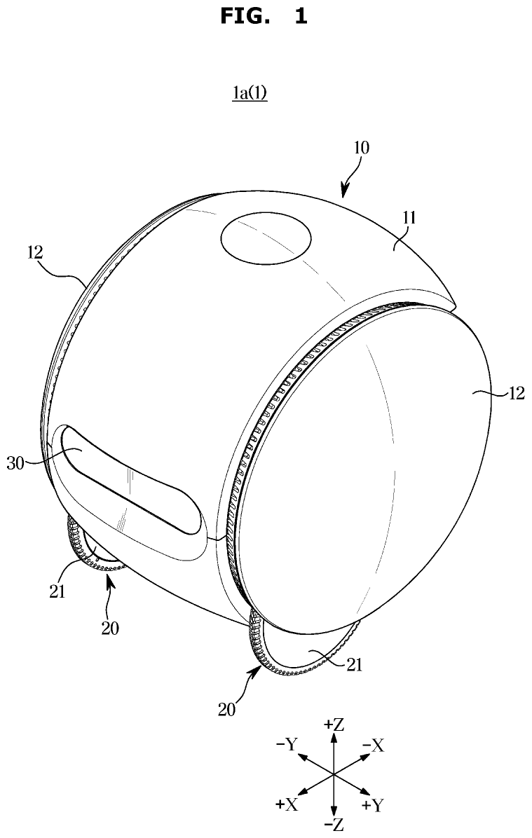

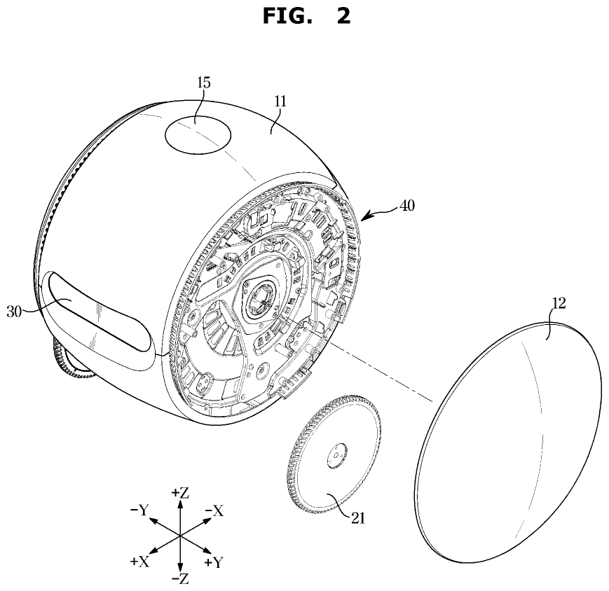

An electronic device 1 according to various embodiments of the present disclosure may perform a specific task while traveling. For example, the electronic device 1 may include a projector 1a, see FIGS. 1 and 2 that is movably provided to project an image onto an arbitrary area. The present disclosure may be applied to any device capable of traveling in addition to the above-described example.

One aspect of the present disclosure provides an electronic device having an improved structure.

One aspect of the present disclosure provides an electronic device in which gears may be easily separated.

One aspect of the present disclosure provides an electronic device that may be manually operated.

The technical objectives of the disclosure are not limited to the above, and other objectives that are not described above will be clearly understood by those skilled in the art from the above detailed description.

FIG. 1 is a perspective view of an electronic device according to an embodiment of the present disclosure. FIG. 2 is an exploded perspective view of an electronic device according to an embodiment of the present disclosure.

Referring to FIGS. 1 and 2, the projector 1a will be described as an example of the electronic device 1.

The projector 1a may be a device configured to project an image onto an arbitrary area. For example, the projector may project an image onto a screen, wall, floor, ceiling, furniture, and the like. The image may include a photograph, a video, text, and the like.

The projector 1a may include a housing 10. The housing 10 may form the exterior of the projector 1a. The housing 10 may be configured to accommodate a light source, an optical member for guiding light emitted from the light source toward a projection lens 30, and an image processing device (e.g., including an LCD panel, a DMD chip, and/or an LCoS panel). The housing 10 may also be referred to as a main body 10 or a case 10.

The projector 1a may include a projection lens 30. The projection lens 30 may be configured to project an image generated by the projector 1a onto an arbitrary area. The projection lens 30 may adjust focus to ensure such that images appear clearly. The projection lens 30 may adjust the size of the image according to a projection distance.

The projector 1a may include a traveling device 20. The traveling device 20 may be detachably mounted on a lower portion of the housing 10. The traveling device 20 may include at least one wheel 21 provided at the lower portion of the housing 10 to move the housing 10. In one example, the traveling device 20 may include a pair of wheels 21. The traveling device 20 may include a wheel drive unit for driving the wheels 21.

The wheels 21 may be rotatable. Specifically, the wheels 21 may be rotatable relative to the housing 10. As the wheels 21 rotate, the projector 1a may move or change its traveling direction.

The housing 10 may include a rotating portion 11 and a fixed portion 12. The rotating portion 11 may be rotatable relative to the fixed portion 12. The projection lens 30 may be disposed on the rotating portion 11. Specifically, the projection lens 30 disposed on the rotating portion 11 may project an image generated by the projector 1a onto areas of various heights. For example, when projecting an image generated by the projector 1a onto a wall, the rotating portion 11 may rotate such that the projection lens 30 faces forward (+X direction). For example, when projecting an image onto a ceiling, the rotating portion 11 may rotate such that the projection lens 30 faces toward the ceiling. Furthermore, in combination with the traveling device 20, the projector 1a may be moved and the projection lens 30 may be rotated such that the projection lens 30 may project the image generated by the projector 1a onto areas of various heights at various locations.

The projector 1a may include a frame 40. The frame 40 may be disposed inside the housing 10. A portion of the frame 40 may be exposed to the outside of the housing 10. The housing 10 may be configured to cover all or part of the frame 40.

The traveling device 20 may be coupled to the frame 40. That is, the wheels 21 may be coupled to the frame 40 so as to rotate.

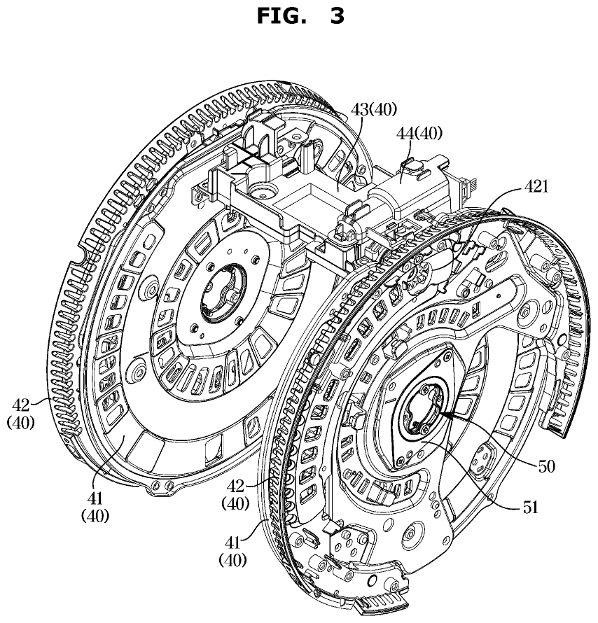

The frame 40 may include a rotating frame 41, see FIG. 3 and a fixed frame 42. The rotating frame 41 may be disposed inside the rotating portion 11.

A portion of the fixed frame 42 may be exposed to the outside of the fixed portion 12. A portion of the fixed frame 42 may be exposed to the outside of the housing 10. A portion of the fixed frame 42 may be disposed inside the fixed portion 12. The fixed portion 12 may be configured to cover one surface of the fixed frame 42.

The rotating frame 41 may be coupled to the rotating portion 11. The fixed frame 42 may be coupled to the fixed portion 12.

The frame 40 may include a gear box. The gear box may be configured to generate power to be transmitted to the traveling device 20 such that the projector 1a may move.

The projector 1a may include a lifting assembly 15. The lifting assembly 15 may include a sensor for detecting an obstacle and components for lifting the sensor outside of the housing 10.

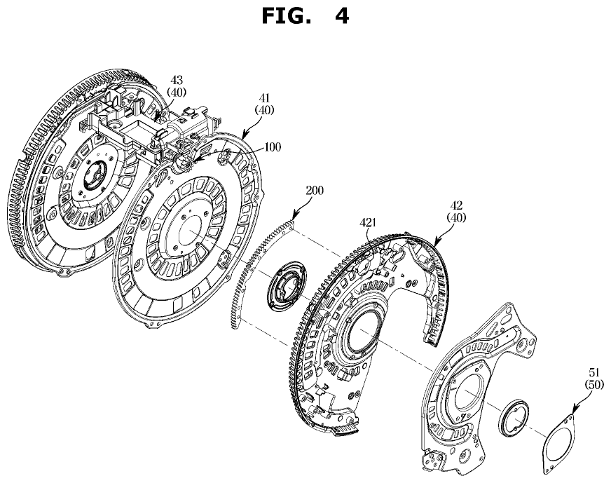

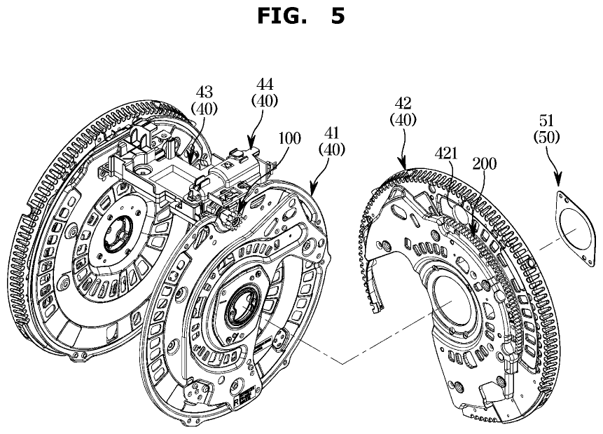

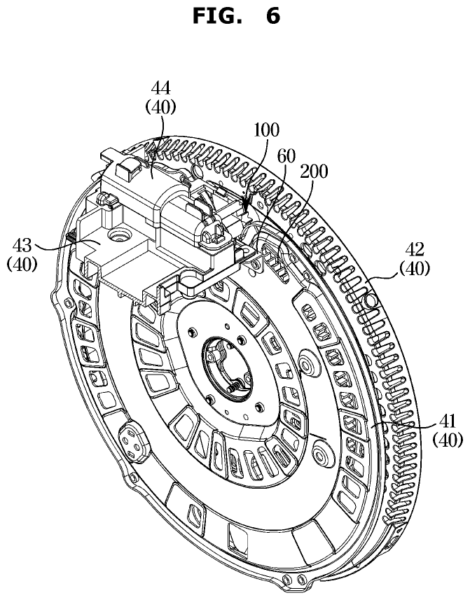

FIG. 3 is a perspective view of the inside of an electronic device according to an embodiment of the present disclosure. FIG. 4 is an exploded view of the inside of an electronic device according to an embodiment of the present disclosure. FIG. 5 is a view showing a fixed frame disassembled from a rotating frame according to an embodiment of the present disclosure. FIG. 6 is a cross-sectional perspective view of an electronic device according to an embodiment of the present disclosure.

The projector 1a may include a base 43. The frame 40 may include the base 43. The base 43 may be disposed inside the rotating portion 11 and may be configured to support the lifting assembly 15. Additionally, the base 43 may configured to connect a pair of rotating frames 41.

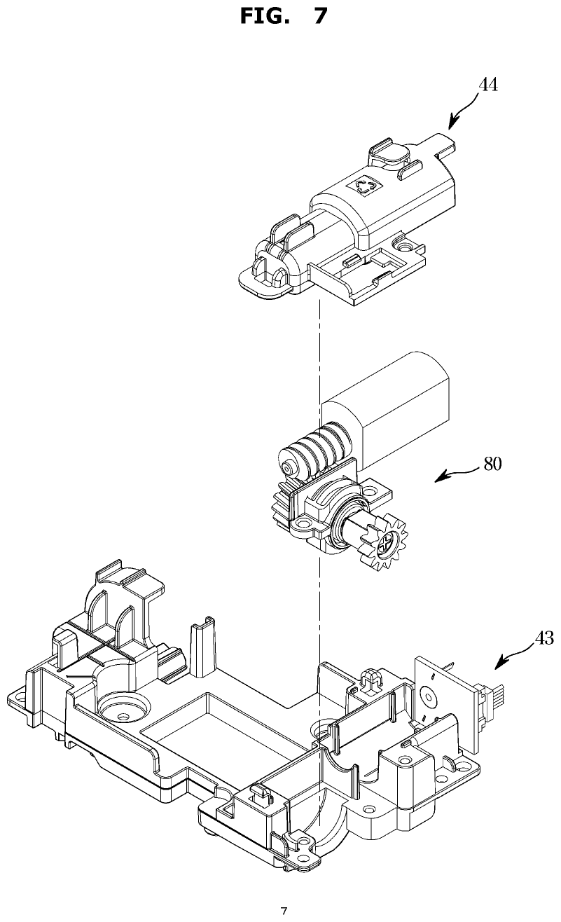

The projector 1a may include a power transmission device 80, see FIG. 7. The base 43 may include a base cover 44 to cover all or part of the power transmission device 80. The base cover 44 may be configured to attenuate and/or suppress vibrations generated from the power transmission device 80.

The base 43 may be coupled to the rotating frame 41 by a frame bracket 60. The base 43 may be configured to connect the pair of rotating frames 41 via a pair of frame brackets 60. The power transmission device 80 may be disposed to transmit power to one of the pair of rotating frames 41.

Even when the power transmission device 80 transmits power to one rotating frame 41, the pair of rotating frames 41 may be provided to be connected by the base 43 so as to rotate together.

The fixed frame 42 may be disposed on an outer side of the rotating frame 41. In some embodiments, the fixed frame 42 may be provided as a pair of fixed frames 42 to be disposed on an outer side of each of the pair of rotating frames 41.

Although the power transmission device 80 is illustrated in the drawings as being disposed inside the rotating portion 11, the disclosure is not limited thereto and includes all configurations and arrangements that may rotate the rotating portion 11 relative to the fixed portion 12. For convenience of description, the following explanation is given with respect to the frame 40 located on a power-transmission side, in which the power transmission device 80 disposed inside the rotating portion 11 transmits power.

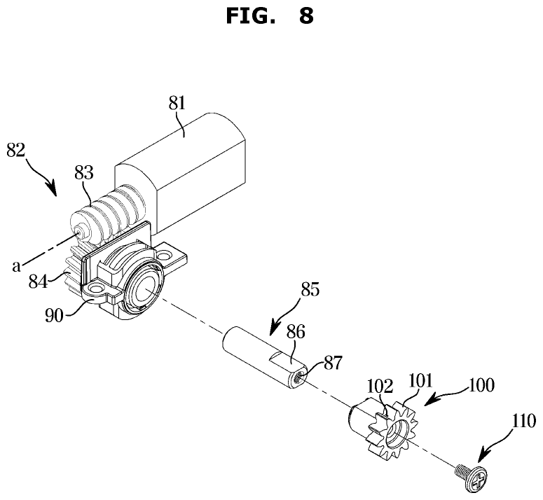

The base 43 may support all or part of the power transmission device 80. The base 43 may support a motor 81 described below. The base 43 may support components of the power transmission device 80, such as a worm gear 82, a rotary shaft 85, and a first gear 100, see FIG. 8.

The projector 1a may include a second gear 200 configured to be connected to the fixed frame 42. The second gear 200 may be coupled to an inner side of the fixed frame 42.

The first gear 100 of the power transmission device 80 and the second gear 200 may be engaged with each other. The first gear 100 may rotate by receiving power from the motor 81 and may be configured to rotate within a range in which the second gear 200 extends. The rotating frame 41 may be configured to rotate within an angular range in which the second gear 200 extends.

When the first gear 100 rotates while being engaged with the second gear 200 coupled to the fixed frame 42, the relative angular position of the rotating frame 41 and the fixed frame 42 may change.

The fixed frame 42 may be supported by the wheel 21 and may not rotate. When the first gear 100 and the second gear 200 rotate while engaged, the relative angular position of the rotating frame 41 and the fixed frame 42 may change, so the rotating frame 41 may be provided to rotate relative to the fixed frame 42.

As the rotating frame 41 rotates relative to the fixed frame 42, the rotating portion 11, which may be coupled to the rotating frame 41, may rotate relative to the fixed portion 12. With this configuration, the projector 1a may project an image or video onto an arbitrary area with the rotating portion 11 rotatable relative to the fixed portion 12.

The projector 1a may include a bearing 50 configured to couple the rotating frame 41 and the fixed frame 42. The bearing 50 may be configured to connect the rotating frame 41 and the fixed frame 42 by penetrating a center of the rotating frame 41 and a center of the fixed frame 42. The rotating frame 41 may rotate about the bearing 50.

The projector 1a may include a bearing cover 51. The bearing cover 51 may support the bearing 50 to secure the bearing 50 and prevent the bearing 50 from being released outward. The bearing cover 51 may be fixed to the outer side of the fixed frame 42.

FIG. 7 is an exploded view depicting a power transmission device according to an embodiment of the present disclosure. FIG. 8 is an exploded view of a power transmission device according to an embodiment of the present disclosure.

Referring to FIGS. 7 and 8, the projector 1a according to an embodiment of the present disclosure may include a power transmission device 80.

The power transmission device 80 may include a motor 81 configured to provide power for rotating the rotating frame 41. The motor 81 may be configured to provide power for rotating the rotating portion 11.

The motor 81 may be provided on the rotating frame 41. The motor 81 may be seated on the base 43. The motor 81 may be supported by the base 43.

The power transmission device 80 may include a worm gear 82. The worm gear 82 may include a worm 83 and a worm wheel 84. The worm 83 may be connected to the motor 81 and may be configured to rotate about axis a of a drive shaft a of the motor 81. The worm 83 may be configured to transmit power of the motor 81 to the worm wheel 84.

The worm wheel 84 may rotate in a direction intersecting a direction in which the worm 83 rotates. The worm wheel 84 may include a helical gear. The power transmission device 80 may transmit power at a high reduction ratio by including the worm gear 82. When the reduction ratio is high, power transmission may be prevented even when rotational output is applied in reverse.

The worm gear 82 may be seated on the base 43 and may be supported by the base 43. The base cover 44 may be configured to cover the motor 81 and the worm gear 82.

The power transmission device 80 may include a rotating shaft 85 and a first gear 100. The rotating shaft 85 may be configured to rotate by the motor 81. The rotating shaft 85 may be configured to transmit power from the worm gear 82 to the first gear 100. The rotating shaft 85 may be coupled to the worm wheel 84 and the first gear 100. For example, the rotating shaft 85 may be coupled to the worm wheel 84 such that the rotation of the worm wheel 84 by the motor 81 causes rotation of the rotating shaft 85.

The rotating shaft 85 may be configured to transmit power to the first gear 100 by including a D-cut portion 86.

The power transmission device 80 may include a bushing 90 configured to cover a part of the rotating shaft 85. The bushing 90 may be seated on the base 43 and may be supported by the base 43. The bushing 90 may be configured to prevent the rotating shaft 85 from being damaged.

The first gear 100 may be configured to rotate about the rotating shaft 85. The first gear 100 may be detachably coupled to the rotating shaft 85. The first gear 110 may be detachably coupled to the rotating shaft 85 at the D-cut portion 86. The first gear 100 may include teeth 101. The teeth 101 may be provided in plural. The first gear 100 may be separable in the extending direction of the teeth 101. When the first gear 100 is separated from the rotating shaft 85, the first gear 100 may also be separated from the second gear 200.

In some embodiments, the first gear 100 may include a spur gear. When the first gear 100 is a spur gear, the first gear 100 may be separable in the same direction as the extension direction of the rotating shaft 85. The teeth 101 of the first gear 100 may extend in the same direction as the extension direction of the rotating shaft 85. The first gear 100 may move in the same direction as the extending direction of the teeth 101 and may be separable from the rotating shaft 85.

In some embodiments, the first gear 100 may include a helical gear. When the first gear 100 is a helical gear, the first gear 100 may be separable in a direction intersecting the extension direction of the rotating shaft 85. The teeth 101 of the first gear 100 may extend in a direction intersecting the extension direction of the rotating shaft 85. The first gear 100 may move in the same direction as the extending direction of the teeth 101 and may be separable from the rotating shaft 85. In the following description, a case in which the first gear 100 is a spur gear will be described.

The first gear 100 may be separable from the rotating shaft 85 in the extending direction of the teeth 101 of the first gear 100.

The first gear 100 may include recesses 102, which are spaces between the plurality of teeth 101. The recesses 102 may be provided as a plurality of recesses 102. The first gear 100 may have ends of the recesses 102 opened to be spaced apart from the second gear 200 in the extending direction of the teeth 101.

The projector 1a may include a fastening member 110. The fastening member 110 may include a screw. The fastening member 110 may be configured to fasten the rotating shaft 85 and the first gear 100 to each other. The fastening member 110 may rotatably couple the first gear 100 to the rotating shaft 85.

The rotating shaft 85 may include a fastening portion 87 formed to receive the fastening member 110 and rotatably couple the first gear 100 to the rotating shaft 85. Threads may be formed in the fastening portion 87.

In the drawings, the fastening member 110 is illustrated as a screw, but the disclosure is not limited thereto and may include any configuration capable of rotatably fastening the first gear 100 to the rotating shaft 85. For example, the fastening member 110 may be an E-ring. When the fastening member 110 is an E-ring, the fastening portion 87 may be formed to be recessed in an outer circumferential surface of the rotating shaft 85.

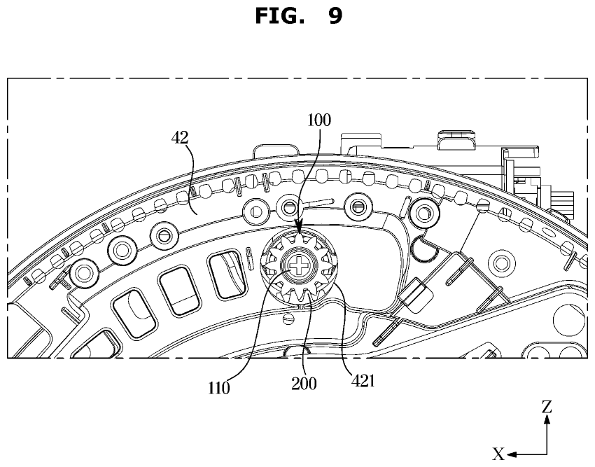

FIG. 9 is an enlarged view of the inside of an electronic device according to an embodiment of the present disclosure.

Referring to FIG. 9, the projector 1a according to an embodiment of the present disclosure may include a through-hole 421 formed in the fixed frame 42. The first gear 100 may be exposed to the outside through the through-hole 421.

The through-hole 421 may be circular. A diameter of the through-hole 421 may be greater than a tip-circle diameter of the first gear 100. An area of the through-hole 421 may be large enough for the first gear 100 to pass therethrough. However, the shape of the through-hole 421 is not limited thereto, and the through-hole 421 may have any shape having an area that allows the first gear 100 to pass through.

The fastening member 110 may be configured to be separable through the through-hole 421. The fastening member 110 may be separable from the rotating shaft 85 through the through-hole 421.

The through-hole 421 may be disposed at a position corresponding to the first gear 100. The through-hole 421 may be disposed such that the fastening member 110 is exposed to the outside of the fixed frame 42. The through-hole 421 may be disposed such that all or part of the first gear 100 is exposed to the outside of the fixed frame 42.

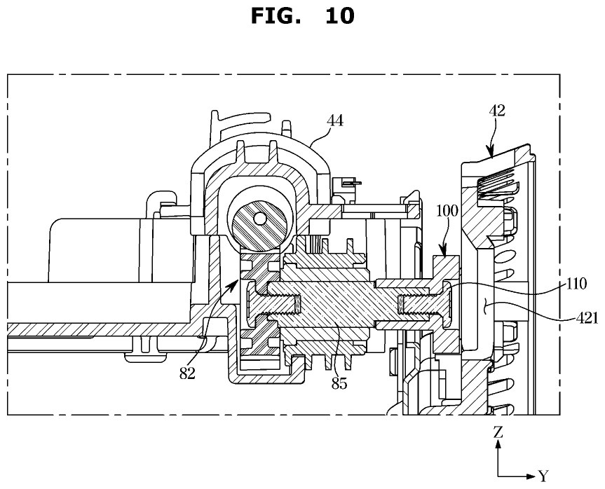

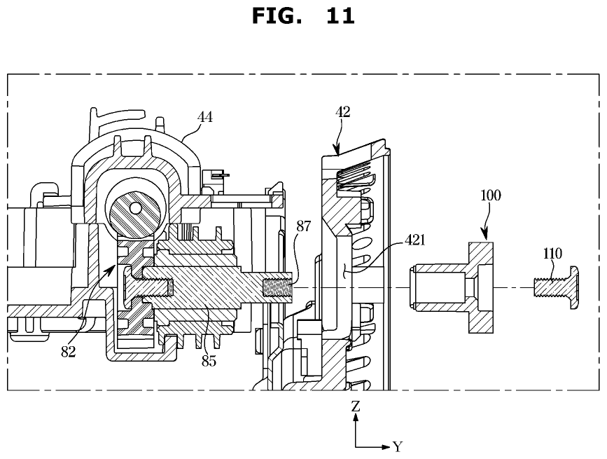

FIG. 10 is a cross-sectional view of an electronic device according to an embodiment of the present disclosure. FIG. 11 is a cross-sectional view of the electronic device shown in FIG. 10 with a first gear separated.

Referring to FIGS. 10 and 11, the projector 1a according to an embodiment of the present disclosure may include the first gear 100 that is provided to be separable from the second gear 200.

The fastening member 110 may pass through the through-hole 421 to enable that the first gear 100 to be separable from the rotating shaft 85. The fastening member 110 may be separable from the first gear 100 through the through-hole 421.

The first gear 100 may be partially or entirely separable from the rotating shaft 85. The first gear 100 may pass through the through-hole 421 to disengage from the second gear 200. The first gear 100 may be spaced apart from the second gear 200. The first gear 100 may pass through the fixed frame 42 via the through-hole 421.

The first gear 100 may pass through the through-hole 421 to separate from the second gear 200. The first gear 100 may be movable in the direction of the through-hole 421 until engagement with the second gear 200 is released.

The through-hole 421 may be disposed such that the first gear 100 moves in the extending direction of the rotating shaft 85 to pass through the fixed frame 42.

However, the present disclosure is not limited to the above-described example, and the arrangement of the through-hole 421 may include any position in which the first gear 100 may move in the extending direction of the teeth 101 and pass through the fixed frame 42.

When the first gear 100 and the second gear 200 are engaged, the power transmission device 80 may not transmit power in a reverse direction of the power transmission direction, and thus the rotating frame 41 may not be rotatable relative to the fixed frame 42 by an external force.

When the first gear 100 and the second gear 200 are separated, the rotating frame 41 may be rotatable relative to the fixed frame 42 by an external force, even when the power transmission device 80 does not transmit power in the reverse direction of the power transmission direction.

An electronic device 1 according to an embodiment includes: a fixed frame 42; a rotating frame 41 rotatable relative to the fixed frame 42; a motor 81 configured to provide power for rotating the rotating frame 41; a rotating shaft 85 configured to be rotated by the motor 81; a first gear 100 detachably coupled to the rotating shaft 85 and rotatable by power from the motor 81 transmitted through the rotating shaft 85; and a second gear 200 configured to engage with the first gear 100 such that the rotating frame 41 rotates relative to the fixed frame 42. The rotating frame 41 is rotatable relative to the fixed frame 42 by external force when the first gear 100 and the second gear 200 are separated.

The electronic device may further include a worm wheel 84 coupled to the rotating shaft 85; and a worm 83engaged with the worm wheel 84 to rotate the worm wheel 84.

The worm 83 may be configured to rotate about a drive shaft a of the motor 81.

A direction in which the drive shaft a extends and a direction in which the rotating shaft 85 may extend intersect each other.

The first gear 100 may be separated from the rotating shaft 85 in a direction in which teeth 101 of the first gear 100 extend.

The first gear 100 may include a spur gear.

The fixed frame 42 may include a through-hole 421 formed to allow the first gear 100 to pass through the fixed frame 42.

The electronic device may further include a fastening member configured to fasten the first gear 100 and the rotating shaft 85.

The fastening member may be configured to be separable from the first gear 100 through the through-hole 421.

The through-hole 421 may be disposed to allow the first gear 100 to move in a direction in which the rotating shaft 85 extends and pass through the fixed frame 42.

The electronic device may further include: a base 43 coupled to the rotating frame 41 and configured to accommodate the motor 81.

The rotating frame 41 may be provided on both sides of the base.

The fixed frame 42 may be provided on an outer side of the rotating frame 41.

The first gear 100 may be movable to an outer side of the rotating frame 41.

The electronic device may further include: a bearing 50 penetrating through the rotating frame 41 and the fixed frame 42 to connect the rotating frame 41 and the fixed frame 42, the rotating frame 41 may rotate about the bearing 50.

A projector 1a for projecting an image according to an embodiment includes: a fixed frame 42; a rotating frame 41 rotatable with respect to the fixed frame 42; a projection lens 30 provided on the rotating frame 41 and configured to project an image onto an arbitrary region; a motor 81 configured to provide power for rotating the rotating frame 41; and a power transmission device 80 configured to transmit the power of the motor 81 to the fixed frame 42. The power transmission device 80 includes a worm gear 82 rotated by the power of the motor 81, and a first gear 100 connected to the worm gear 82 and rotatable therewith. The projector 1a further includes a second gear 200 connected to the fixed frame 42 and configured to engage with the first gear 100. The first gear 100 is separable from the second gear 200.

The fixed frame 42 is disposed on an outer side of the rotating frame 41, and the first gear 100 is separable toward an outer side of the rotating frame 41.

The fixed frame 42 may include a through-hole 421 formed such that the first gear 100 passes through the fixed frame 42.

An electronic device 1 according to an embodiment includes: a fixed frame 42; a rotating frame 41 rotatable with respect to the fixed frame 42; a motor 81 provided on the rotating frame 41; a worm gear 82 rotated by the power of the motor 81; a rotating shaft 85 rotated by the worm gear 82; a first gear 100 rotatable by the power of the motor 81 transmitted through the rotating shaft 85; and a second gear 200 configured to engage with the first gear 100 such that the rotating frame 41 rotates with respect to the fixed frame 42. The rotating frame 41 is rotatable with respect to the fixed frame 42 by an external force when the first gear 100 and the second gear 200 are separated.

The first gear 100 may be configured to be spaced apart from the second gear 200 by moving in a direction in which the rotating shaft 85 extends.

According to the spirit of the present disclosure, the first gear may be separable from the second gear without separating the rotating frame and the fixed frame. Accordingly, regardless of the power transmission direction of the power transmission device, the rotating frame may rotate relative to the fixed frame.

According to the spirit of the present disclosure, the electronic device may include a structure in which engagement between the first gear and the second gear is released. Accordingly, the electronic device may include a power transmission assembly having a high reduction ratio, thereby effectively transmitting power.

According to the spirit of the present disclosure, even when a failure occurs in the worm gear and/or the motor, the product may be disassembled.

The effects of the disclosure are not limited to the effects described above, and other effects that are not described will be clearly understood by those skilled in the art from the above detailed description.

Although the disclosure has been shown and described in relation to specific embodiments, it would be appreciated by those skilled in the art that changes and modifications may be made in these embodiments without departing from the principles and scope of the disclosure, the scope of which is defined in the claims and their equivalents.

What is claimed is:

1. An electronic device comprising:
a fixed frame;
a rotating frame rotatable relative to the fixed frame;
a motor configured to provide power for rotating the rotating frame;
a rotating shaft configured to be rotated by the motor;
a first gear detachably coupled to the rotating shaft and rotatable by power from the motor transmitted through the rotating shaft; and
a second gear configured to engage with the first gear such that the rotating frame rotates relative to the fixed frame,
wherein the first gear is configured to disengage from the second gear, and
wherein the rotating frame is rotatable relative to the fixed frame by an external force in a state in which the first gear and the second gear are disengaged.

2. The electronic device of claim 1, further comprising:
a worm wheel coupled to the rotating shaft; and
a worm engaged with the worm wheel and configured to rotate the worm wheel and transmit rotation to the rotating shaft.

3. The electronic device of claim 2, wherein the worm is configured to rotate about a drive shaft of the motor.

4. The electronic device of claim 3, wherein a direction in which the drive shaft extends intersects with a direction in which the rotating shaft extends.

5. The electronic device of claim 1, wherein the first gear is separable from the rotating shaft in a direction in which teeth of the first gear extend.

6. The electronic device of claim 5, wherein the first gear comprises a spur gear.

7. The electronic device of claim 1, wherein the fixed frame includes a through-hole formed to allow the first gear to pass through the fixed frame.

8. The electronic device of claim 7, further comprising
a fastening member configured to fasten the first gear and the rotating shaft.

9. The electronic device of claim 8, wherein the fastening member is configured to be separable from the first gear through the through-hole.

10. The electronic device of claim 9, wherein the through-hole is disposed so that the first gear is movable in a direction in which the rotating shaft extends to pass through the fixed frame.

11. The electronic device of claim 1, further comprising
a base coupled to the rotating frame and configured to accommodate the motor.

12. The electronic device of claim 11, wherein the rotating frame comprises two rotating frames and each rotating frame is provided on opposing sides of the base.

13. The electronic device of claim 12, wherein the fixed frame comprises two fixed frames, and each fixed frame is provided on an outer side of each rotating frame.

14. The electronic device of claim 13, wherein the first gear is movable to the outer side of one of the two rotating frames.

15. The electronic device of claim 1, further comprising: a bearing penetrating through the rotating frame and connecting the rotating frame and the fixed frame,
wherein the rotating frame rotates about the bearing.

16. The electronic device of claim 7, wherein the first gear is configured to pass through the through-hole to disengage from the second gear.

17. The electronic device of claim 1, wherein the second gear is coupled to the fixed frame.

18. The electronic device of claim 1, wherein the rotating shaft includes a D-cut portion, and
wherein the first gear is configured to be detachably coupled to the D-cut portion.

19. The electronic device of claim 11, wherein the base comprises a base cover configured to cover at least a portion of the motor and suppress vibrations generated by the motor.

20. The electronic device of claim 1, further comprising
a projection lens configured to project an image, wherein
a projection direction of the image from the projection lens is adjusted by rotation of the rotating frame.
